(19) United States
(12) Patent Application Publication
(10) Pub. No.: US 2020/0036888 A1
(43) Pub. Date: Jan. 30, 2020

(54) Calibration of Automatic White Balancing using Facial Images

(71) Applicant: QUALCOMM Incorporated, San Diego, CA (US)

(72) Inventors: Ho Sang Lee, San Diego, CA (US); Soman Ganesh Nikhara, Hyderabad (IN)

(21) Appl. No.: 16/046,408

(22) Filed: Jul. 26, 2018

(51) Int. Cl. H04N 5/232; H04N 9/73; H04N 5/235

(52) U.S. Cl. CPC H04N 5/23219; H04N 5/2352; H04N 9/735

(57) ABSTRACT

Methods, systems, and apparatuses are provide to perform automatic white balancing. For example, the methods receive, from a plurality of sensing elements in a sensor array, first image data corresponding to an image of a target scene that includes a human face. The methods also detect a region of the image that includes the human face, identify a portion of the first image data that corresponds to the detected region, and compute first gain values based on the identified portion of the first image data and reference image data that characterizes the human face. Further, the methods perform an automatic white balancing operation on the first image data based on the first gain values.

### BACKGROUND

### Field of the Disclosure

This disclosure generally relates to optical systems and processes and more specifically relates to a calibration of automatic white balancing using facial images.

### Description of Related Art

Many mobile devices incorporate imaging sensors and hardware configured to capture and present image data to users. These devices, such as smartphones, tablet computers, and laptop computers, are often capable of performing automatic white balancing (AWB) operations on captured image data to ensure color constancy under various illumination conditions. Further, many image capture devices also implement biometric authentication processes that authenticate an identity of an operator based on based on captured images that include a face of the operator.

### SUMMARY

Disclosed computer-implemented methods for performing automatic white balancing include receiving, by one or more processors, first image data from a plurality of sensing elements in a sensor array. The first image data can corresponding to an image of a target scene that includes a human face. The methods can further include, by the one or more processors, detecting a region of the image that includes the human face, identifying a portion of the first image data that corresponds to the detected region, and computing first gain values based on the identified portion of the first image data and reference image data that characterizes the human face. The method can include performing, by the one or more processors, an automatic white balancing operation on the first image data based on the first gain values.

A disclosed device for performing automatic white balancing can include a non-transitory, machine-readable storage medium storing instructions, and at least one processor configured to be coupled to the non-transitory, machine-readable storage medium. The at least one processor can be configured by the instructions to receive, first image data from a plurality of sensing elements in a sensor array. The first image data can correspond to an image of a target scene that includes a human face. The at least one processor can be further configured by the instructions to detect a region of the image that includes the human face and identify a portion of the first image data that corresponds to the detected region, and compute first gain values based on the identified portion of the first image data and reference image data that characterizes the human face. The at least one processor can be further configured by the instructions to perform an automatic white balancing operation on the first image data based on the first gain values.

A disclosed apparatus for performing automatic white balancing includes means for receiving first image data from a plurality of sensing elements in a sensor array. The first image data can correspond to an image of a target scene that includes a human face. The disclosed apparatus also includes means for detecting a region of the image that includes the human face and for identifying a portion of the first image data that corresponds to the detected region, and means for computing first gain values based on the identified portion of the first image data and reference image data that characterizes the human face. Additionally, the apparatus includes means for performing an automatic white balancing operation on the first image data based on the first gain values.

A disclosed non-transitory, machine-readable storage medium stores program instructions that, when executed by at least one processor, perform a method for performing automatic white balancing. The machine-readable storage medium includes instructions for receiving first image data from a plurality of sensing elements in a sensor array. The first image data can correspond to an image of a target scene that includes a human face. The machine-readable storage medium also includes instructions for detecting a region of the image that includes the human face and for identifying a portion of the first image data that corresponds to the detected region, and instructions for computing first gain values based on the identified portion of the first image data and reference image data that characterizes the human face. Additionally, the machine-readable storage medium includes instructions for performing an automatic white balancing operation on the first image data based on the first gain values.

### BRIEF DESCRIPTION OF DRAWINGS

FIGS. 1 and 2 are diagrams illustrating components of an exemplary mobile device, according to some examples.

FIG. 3A is a diagram illustrating portions of an exemplary reference image, according to some examples.

FIGS. 3B and 3C are diagrams illustrating exemplary mappings of color component values within a two-dimensional coordinate space, according to some examples.

FIG. 4A is a diagram illustrating portions of an exemplary captured image, according to some examples.

FIG. 4B is a diagram illustrating an exemplary mapping of color component values within a two-dimensional coordinate space, according to some examples.

FIG. 5 is a flowchart of an exemplary process for performing a face-assisted calibration of an automatic white balancing operation, according to some examples.

FIG. 6 is a flowchart of an exemplary process for performing face-assisted automatic white balancing operations, according to some examples.

### DETAILED DESCRIPTION

While the features, methods, devices, and systems described herein can be embodied in various forms, some exemplary and non-limiting embodiments are shown in the drawings, and are described below. Some of the components described in this disclosure are optional, and some implementations can include additional, different, or fewer components from those expressly described in this disclosure.

Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) refer to the orientation as then described or as shown in the drawing under discussion. Relative terms are provided for the reader's convenience. They do not limit the scope of the claims.

Many mobile devices, such as smartphones, tablet computers, or laptop computers, include one or more imaging assemblies configured to capture image data characterizing a target scene. For example, these imaging assemblies can include one or more optical elements, such as an assembly of one or more lenses (e.g., a lens assembly) that collimate and focus incident light onto an array of sensing elements disposed at a corresponding imaging plane (e.g., a sensor array composed of sensing elements formed within a semiconductor substrate).

Each of the sensing elements can collect incident light and generate an electrical signal, which characterizes and measures a value of a luminance of the incident light and further, a chrominance of the incident light. One or more processors of the mobile devices, such as an image signal processor, can convert the generated electrical signals representing luminance and/or chrominance values into corresponding image data characterizing the target scene, which can be stored within one or more non-transitory, machine-readable memories as image data, which can be processed for presentation on a corresponding display unit.

Due to variations in a color temperature of the incident light, the mobile devices can also perform one or more automatic white balancing (AWB) operations that adjust a color of portions of the image data captured by the one or more imaging assemblies under different illuminations. These AWB operations can include, among other things, processes that perform an independent gain regulation of each color component of the captured image data (e.g., values of red, green, and blue color components), and that generate “corrected” image data corresponding to an image of the target scene captured under a standard illuminant. By way of example, the standard illuminant can be estimated explicitly by the AWB operations (e.g., a perfect gray illuminant characterized by respective color component ratios of unity), or cam be estimated implicitly through one or more assumptions regarding an effect or impact of the standard illuminant on the corrected image data.

In some instances, the explicit or implicit estimation of the standard illuminant can introduce inaccuracies in portions of the corrected image data. For example, the set of potential illuminants (e.g., from which the mobile devices select the standard illuminant) may not characterize accurately or fully the color temperature of the incident light, or the assumptions supporting the implicit selection of the standard illuminant may not properly account for certain of the illumination conditions under which the one or more imaging assemblies captured the image of the target scene (e.g., the assumptions may be ill-tailored to a facial tone of one or more individuals within the target scene). When presented by a mobile device on a corresponding display unit, the inaccuracies within the portions of the corrected image data can generate one or more defects visible to a user of the mobile device.

In other examples, and as described herein, the inaccuracies introduced into the AWB-corrected image data by the explicit or implicit section of the standard illuminant can be mediated through an implementation, by a mobile device, of one or more face-assisted AWB calibration processes that leverage captured image data characterizing a target scene that includes a face of the user of the mobile device (e.g., a captured “facial” image). By way of example, many mobile devices, such as smartphones, tablet computers, include front-facing imaging assemblies, such as front-facing digital cameras, configured to capture facial images that include a portion of the user's face disposed against corresponding background elements.

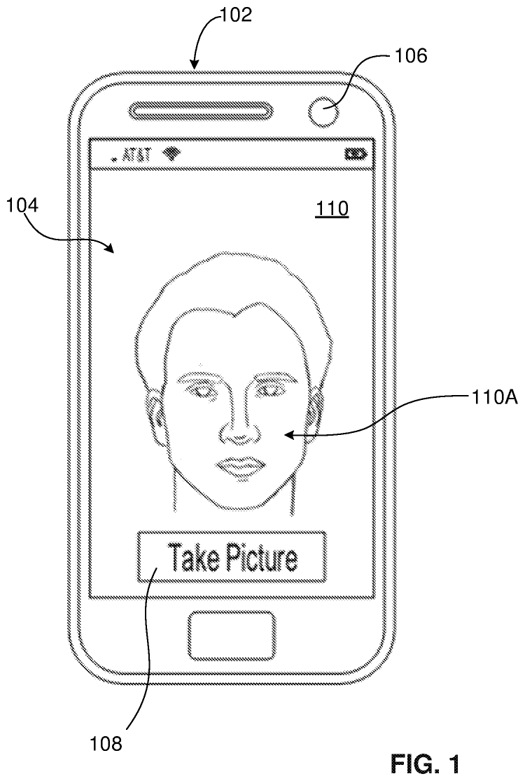

For instance, as illustrated in FIG. 1, mobile device 102 can include a display unit 104 (e.g., a pressure-sensitive touchscreen display unit), and a front-facing imaging assembly 106 (e.g., a front-facing digital camera). Mobile device 102 may also be configured to present, on display unit 104, one or more interface elements 108 that, when selected by the user, causes front-facing imaging assembly 106 to capture a facial image 110 that includes a face 110A of the user, and to display facial image 110 on display unit 104. For example, to generate displayed facial image 110, a lens assembly of front-facing imaging assembly 106 may focus incident light onto each of respective sensing elements within the sensor array (not illustrated in FIG. 1). The sensing elements measure the luminance of the incident light, and the red, green, and blue color components of that incident light, and an image signal processor converts the data representing luminance and chrominance values into corresponding image data (also not illustrated in FIG. 1). Mobile device 102 causes the corresponding image data, which characterizes captured facial image 110, to be displayed on display unit 104.

Further, and by way of example, many mobile devices, such as mobile device 102 of FIG. 1, can perform additional operations that authenticate an identity of the user based on a comparison between captured facial images and one or more reference facial images locally maintained by mobile device 102 within a non-transitory, machine-readable storage medium. For example, and during an initial configuration process, mobile device 102 captures one or more facial images, such as facial image 110, and stores portions of the image data characterizing these captured facial images as reference image data, e.g., within the non-transitory, machine-readable storage medium. Additionally, and subsequent to its initial configuration, mobile device 102 can perform operations that authenticate the identity of the user (e.g., prior to unlocking mobile device 102, etc.) based on a comparison between one or more additional captured facial images and portions of the locally maintained reference image data.

In some exemplary implementations, as described herein, mobile device 102 can perform operations that calibrate a face-assisted automatic white balancing (AWB) process based on portions of the reference image data associated with one or more facial images of the user of mobile device 102. Further, and based a performance of one or more of these exemplary calibration processes, mobile device 102 can generate true color reference (TCR) data that establishes a true color reference for the user's face under a standard illuminant, such as, but not limited to, a perfect gray illuminant characterized by respective color component ratios of unity.

In further exemplary implementations, mobile device 102 may detect all or a portion of the user's face (e.g., face 110A of FIG. 1), within additional image data characterizing a subsequently captured image. In response to the detection of user face 110A, mobile device 102 can perform any of the exemplary, face-assisted AWB correction processes described herein to determine a region-of-interest within the captured image that includes all or the portion of user face 110A, and identify a portion of the additional image data that corresponds to the determined region-of-interest. Further, and as described herein, mobile device 102 can perform any of the exemplary, face-assisted AWB correction processes described herein to compute AWB correction gain values based on the identified portion of the additional image data and the TCR data that establishes the true color reference for user face 110A. By calculating the AWB correction gain values based on the true color reference for user face 110A, and not based on an implicitly or explicitly selected standard illuminant, the exemplary face-assisted AWB correction processes described herein may increase an accuracy of any resulting corrected image data, and reduce an incidence of visual defects within presented portions of that corrected image data.

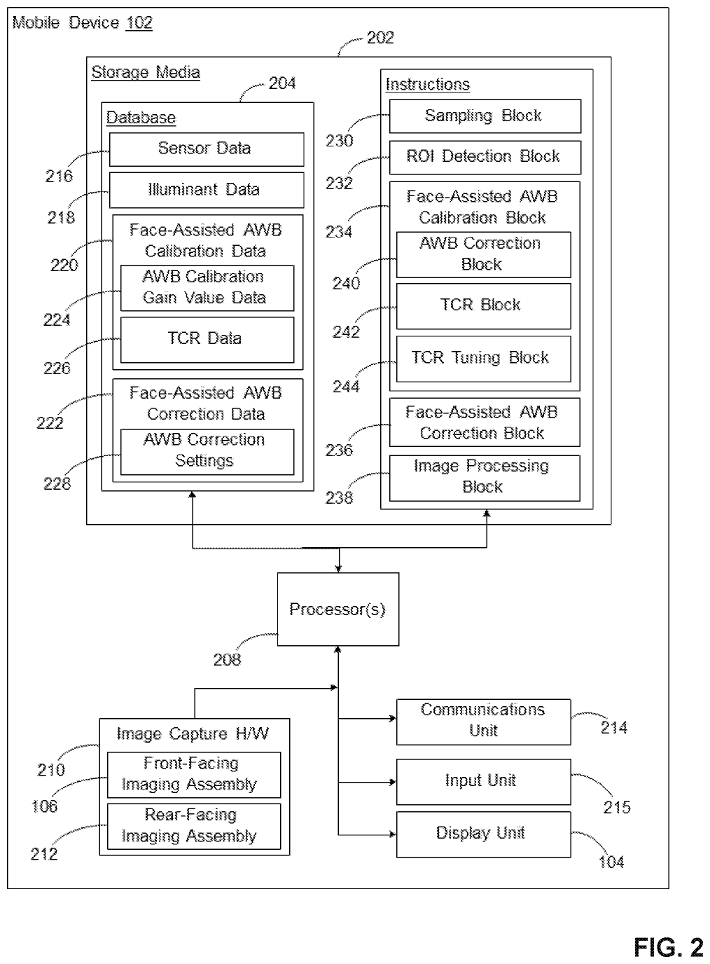

FIG. 2 is a schematic block diagram illustrating exemplary components of a mobile device, such as mobile device 102 of FIG. 1. Examples of mobile device 102 include, but are not limited to, a smartphone, a tablet computer, a laptop or desktop computer, a digital camera, and additional or alternative mobile devices or communications devices. Mobile device 102 can include a tangible, non-transitory, machine-readable storage medium (e.g., “storage media”) 202 having a database 204 and instructions 206 stored thereon. Mobile device 102 can also include one or more processors, such as processor 208, for executing instructions 206 or for facilitating storage and retrieval of data at database 204.

Processor 208 can be coupled to image capture hardware 210, which includes a front-facing imaging assembly 106 and in some instances, a rear-facing imaging assembly 212. By way of example, and as described herein, each of front-facing imaging assembly 106 and rear-facing imaging assembly 212 can include a digital camera having a lens assembly that focus incoming light onto sensing elements disposed within a corresponding sensor array.

Further, processor 208 can also be coupled to a communications interface 214, to one or more input units, such as input unit 215, and to display unit 104. In some instances, communications interface 214 facilitates communications between mobile device 102 and one or more network-connected computing systems or devices across a communications network using any suitable communications protocol. Examples of these communications protocols include, but are not limited to, cellular communication protocols such as code-division multiple access (CDMA®), Global System for Mobile Communication (GSM®), or Wideband Code Division Multiple Access (WCDMA®) and/or wireless local area network protocols such as IEEE 802.11 (WiFi®) or Worldwide Interoperability for Microwave Access (WiMAX®).

Input unit 215 may, in some instances, be configured to receive input from a user of mobile device 102, and examples of input unit 215 include, but are not limited to, one or more physical buttons, keyboards, controllers, microphones, pointing devices, and/or pressure-sensitive surfaces. Display unit 104 can include, but is not limited to, an LED display screen or a pressure-sensitive touchscreen display unit. Further, in some instances, input unit 215 and display unit 104 can be incorporated into a single element of hardware, such the pressure-sensitive touchscreen described herein.

By way of example, processor 208 can include one or more distinct processors, each having one or more cores. Each of the distinct processors can have the same structure or respectively different structure. Processor 208 can also include one or more central processing units (CPUs), one or more graphics processing units (GPUs), application specific integrated circuits (ASICs), digital signal processors (DSPs), or combinations thereof. If processor 208 is a general-purpose processor, processor 208 can be “configured to” by instructions 206 to serve as a special-purpose processor and perform a certain function or operation. Further, in some examples, a single processor 208 performs image processing functions and other instruction processing, such as a calibration and a performance of any of the exemplary face-assisted AWB correction processes described herein. In other examples, mobile device 102 can include a separate image signal processor that performs image processing.

Database 204 can include a variety of data, such as sensor data 216, illuminant data 218, face-assisted AWB calibration data 220, and face-assisted AWB correction data 222. For example, sensor data 216 can include data (e.g., image data) characterizing one or more images of target scenes or user faces captured by front-facing imaging assembly 106 or rear-facing imaging assembly 212. Further, and as described herein, the image data can include, but is not limited to, data specifying values of luminance and/or color components (e.g., red, blue, or green color component values) measured by each of the sensing elements or sensor arrays incorporated into front-facing imaging assembly 106 or rear-facing imaging assembly 212.

In some instances, the image data can characterize a reference image that includes a portion of the face of the user of mobile device 102 (e.g., a portion of face 110A) disposed against a background having specified color characteristics (e.g., a white background, a gray background, etc.), and the image data characterizing the reference image can represent an input to the exemplary, face-assisted AWB calibration processes described herein. Further, the image data can also characterize one or more additional captured images, the color component values of which can be adjusted using any of the exemplary, face-assisted AWB correction processes described herein.

Illuminant data 218 can include information that identifies and characterizes one or more standard illuminants, such as, but not limited to, the “perfect gray” illuminant described herein. Each of the standard illuminants can be characterized by corresponding ratios of color component values, such as a ratio of red-to-green (R/G) color component values and a ratio of blue-to-green (B/G) color component values, and illuminant data 218 can maintain the ratios of the color component values that characterize each of the standard illuminants, along with additional or alternate information that identifies or defines the standard illuminants.

Face-assisted AWB calibration data 220 can include, but is not limited to, information that facilitates a performance of any of the exemplary face-assisted AWB calibration processes described herein, or information indicative of an output of these exemplary face-assisted AWB calibration processes. For example, as illustrated in FIG. 2, face-assisted AWB calibration data 220 may include AWB calibration gain value data 224 and TCR data 226.

For example, AWB calibration gain value data 224 include AWB calibration gain values that, when applied to color component values associated with a particular region of the reference image (e.g., an “illuminant” region of that reference image), correct these color component values such that the corresponding color component values (and/or color component ratios) of the illuminant region are consistent with a standard illuminant. Examples of the standard illuminant include, but are not limited to, a perfect gray illuminant characterized by respective R/G and B/G color component ratios of unity.

Further, true color reference (TCR) data 226 establishes a true color reference for a user's face under the standard illuminant, e.g., the perfect gray illuminant described herein. For example, the reference image can include a portion of the user's face (e.g., disposed within a “facial” region of the reference image), and one or more of the exemplary, face-assisted AWB calibration processes described herein to can adjust luminance and/or color component values within the facial region of reference image in accordance with the AWB calibration gain values to generate the true color reference for the user's face. As described herein, TCR data 226 specifies the adjusted color component values (e.g., adjusted red, blue, or green color component values), which collectively establish the true color reference of the user's face under the standard illuminant.

Face-assisted AWB correction data 222 can include, but is not limited to, information that facilitates a performance of any of the exemplary face-assisted AWB correction processes described herein, or information indicative of an output of these exemplary face-assisted AWB correction processes. For example, as illustrated in FIG. 2, face-assisted AWB correction data 222 may include AWB correction settings 228 that specify AWB correction gain values generated through the exemplary, face-assisted AWB correction processes described herein. In some instances, and when applied to color component values associated with a region of a captured image that includes the user's face (e.g., a “facial” region of the captured image), the AWB correction gain values adjust these color component values for consistency with, and conformance to, the true color reference for the user's face.

To facilitate understanding of the examples, instructions 206 are in some cases described in terms of one or more blocks configured to perform particular operations. As illustrated in FIG. 2, instructions 206 can include, but are not limited to, a sampling block 230, a region-of-interest (ROI) detection block 232, a face-assisted AWB calibration block 234, a face-assisted AWB correction block 236, and an image processing block 238.

Sampling block 230 provides a means for receiving image data from the sensing elements incorporated into each of front-facing imaging assembly 106 and rear-facing imaging assembly 212. As described herein, the sensing elements can be disposed within corresponding sensor arrays incorporated into each of front-facing imaging assembly 106 and rear-facing imaging assembly 212, and the received data includes values of luminance and/or color components (e.g., red, green, and blue color component values) measured by each of the sensing elements. In some instances, the received luminance values and/or the received color component values collectively establish the image data that characterizes an image of a target scene captured by front-facing imaging assembly 106 or rear-facing imaging assembly 212

Sampling block 230 can also perform operations that store the received luminance or color component values within a corresponding portion of database 204, e.g., sensor data 216. Further, sampling block 230 can perform operations that initiate execution of one or more of instructions 206, such as ROI detection block 232, face-assisted AWB calibration block 234, face-assisted AWB correction block 236, or image processing block 238, based on commands provided through a corresponding program interface. Examples of the corresponding program interface include, but are not limited to, an application programming interface (API) associated with ROI detection block 232, face-assisted AWB calibration block 234, face-assisted AWB correction block 236, or image processing block 238.

ROI detection block 232 provides a means for processing the received image data, which includes the luminance or color component values, to detect one or more regions-of-interest (ROIs) within the captured image. The one or more detected ROIs include, but are not limited to, the facial region and the illuminant region described herein, and each of the detected ROIs may be characterized by a boundary having a predetermined geometry (e.g., a square, a circle, etc.) and a predetermined dimension (e.g., a predetermined number of sensing elements). Further, ROI detection block 232 can detect the facial region and/or the illuminant region the captured image based on an application of one or more facial recognition algorithms or feature detection algorithms to the received luminance or color component values that characterize the captured image. ROI detection block 232 can also provide a means for identifying portions of the received image data that correspond to the detected ROIs, and for storing data characterizing detected ROIs, such the identified portions of the received image data, within database 204, e.g., within sensor data 216.

Face-assisted AWB calibration block 234 provides a means for generating data that establishes a true color reference for the user's face based on luminance or color component values that characterize a reference image. The reference image may, for instance, be captured by front-facing imaging assembly 106 of mobile device 102 (e.g., a front-facing digital camera). To implement the exemplary, face-assisted AWB calibration processes described herein, face-assisted AWB calibration block 234 can include an AWB correction block 240, a true color reference (TCR) block 242, and a TCR tuning block 244, which perform collective operations that establish or modify the true color reference for the user's face.

AWB correction block 240 can perform any of the exemplary, face-assisted AWB calibration processes described herein to compute AWB calibration gain values that, when applied to the color component values associated with an illuminant region of a reference image, correct those color component values for consistency with, and conformance to, a standard illuminant. For example, AWB correction block 240 can access database 204, and obtain illuminant information characterizing the standard illuminant, such as, but not limited to, the perfect gray illuminant described herein (e.g., from a portion of illuminant data 218). AWB correction block 240 may also obtain, from sensor data 216, illuminant region data that specifies the color component values associated the illuminant region of the reference image. As described herein, the illuminant region of the reference image may be characterized by a boundary that include a predetermined number of sensing elements (e.g., as established by ROI detection block 232), and the illuminant region data may specify the color component value measured by each of the predetermined number of sensing elements.

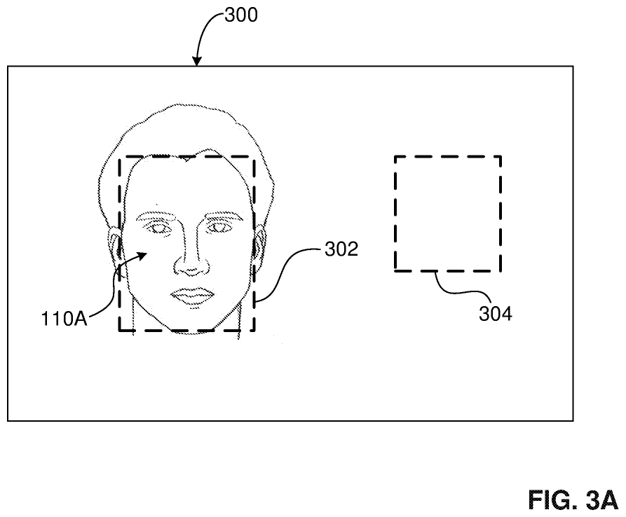

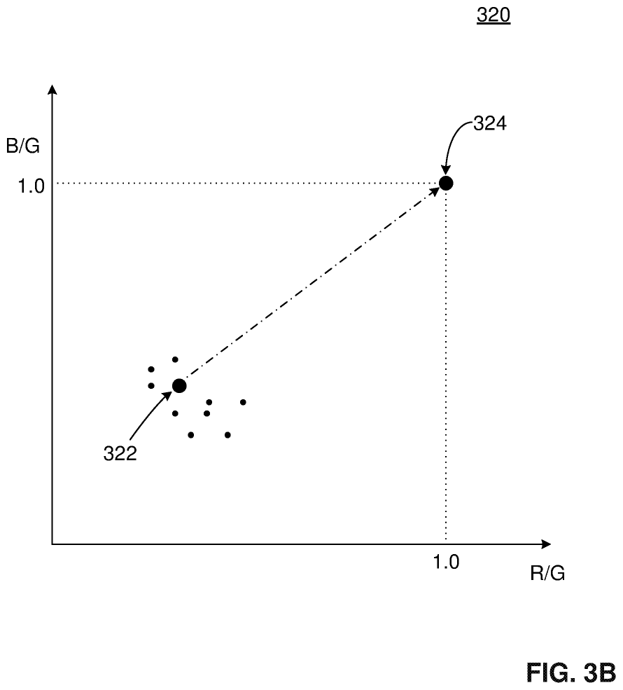

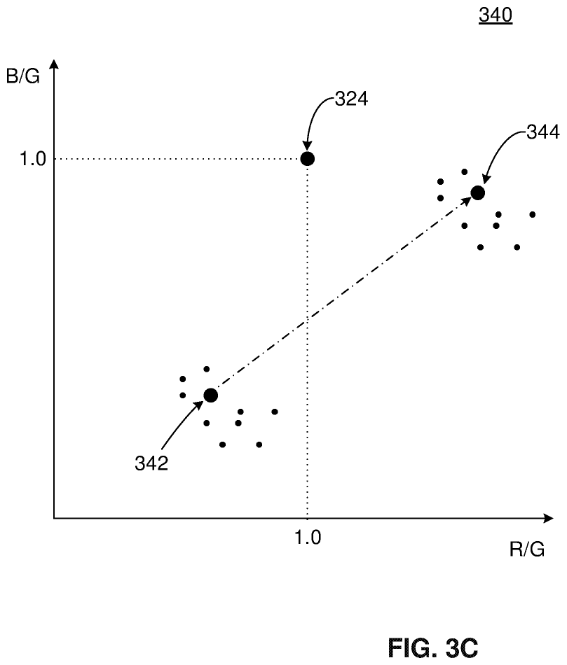

By way of example, and as illustrated in FIG. 3A, the captured reference image, e.g., reference image 300, includes a facial region 302, which incorporates a portion of the user face (e.g., user face 110A), and an illuminant region 304, which incorporates a portion of a background of a specified color or range of colors, such as, but not limited to, a gray or a white background of reference image 300. As described herein, ROI detection block 232 can perform any of the exemplary processes described herein to generate, and store within sensor data 216, facial region data that identifies facial region 302, and that specifies color component values associated with facial region 302 (e.g., as measured by sensing elements incorporated within the boundaries of facial region 302). For instance, ROI detection block 232 can identify a subset of the sensing elements that correspond to facial region 302 and incorporate, within the facial region data, the color component values measured by the identified subset of the sensing elements.

In additional instances, ROI detection block 232 can perform any of the exemplary processes described herein to generate, and store within sensor data 216, illuminant region data that identifies illuminant region 304, and that specifies color component values associated with illuminant region 304 (e.g., as measured by sensing elements incorporated within the boundaries of illuminant region 304). For example, ROI detection block 232 can identify an additional subset of the sensing elements that correspond to illuminant region 304 and incorporate, within the illuminant region data identifying illuminant region 304, the color component values measured by each of the additional subset of the sensing elements.

AWB correction block 240 can process the illuminant region data to compute a red-to-green (R/G) color component ratio and a blue-to-green (B/G) color component ratio for each triplet of color component values (e.g., the red, green, and blue color component values) included within the illuminant region data. AWB correction block 240 can also map (and in some instances, quantize) the computed R/G and B/G color component ratios that characterize illuminant region 304 into a grid within a two-dimensional coordinate space, e.g., as parameterized by the R/G and B/G color component ratios. FIG. 3B illustrates an exemplary mapping 320 of the color component ratios of illuminant region 304, shown generally as illuminant data points 322, within the two-dimensional coordinate space parameterized by the corresponding R/G and B/G color component ratios. Further, and as illustrated in FIG. 3B, mapping 320 also identifies a data point 324 characterizing the standard illuminant, such as, but not limited to, the perfect gray illuminant having corresponding R/G and B/G color component ratios of unity.

AWB correction block 240 can also compute the AWB calibration gain values that correct the R/G and B/G color component ratios, and as such, the color component values, associated with illuminant region 304 (as represented by illuminant data points 322 within FIG. 3B), and generate corrected R/G and B/G values that are consistent with, and conform to, the standard illuminant (as represented by standard illuminant data point 324 of FIG. 3B). By way of example, AWB correction block 240 can compute the AWB calibration gain values associated with illuminant region 304 by performing operations that invert a color correction matrix (CCM) capable of transforming the color component values of illuminant region 304 into the standard illuminant. AWB correction block 240 can perform additional operation that store the AWB calibration gain values within a corresponding portion of database 204, e.g., within AWB calibration gain value data 224.

In further examples, TCR block 242 can perform any of the exemplary, face-assisted AWB calibration processes described herein to compute the true color reference for user face 110A based on an application of the computed AWB calibration gain values to the color component values associated with facial region 302 of reference image 300. For instance, TCR block 242 can access database 204, and obtain, from sensor data 216, facial region data that specifies the red, green, and blue color component values associated with facial region 302 of reference image 300.

TCR block 242 can process the facial region data to compute a red-to-green color (R/G) component ratio and a blue-to-green (B/G) color component ratio for each triplet of color component values (e.g., the red, green, and blue color component values) included within the facial region data. TCR block 242 can also map (and in some instances, quantize) the computed R/G and B/G color component ratios that characterize facial region 302 into a grid within a two-dimensional coordinate space, e.g., as parameterized by the R/G and B/G color component ratios. FIG. 3C illustrates an exemplary mapping 340 of the color component ratios of facial region 302, shown generally as facial data points 342, within the two-dimensional coordinate space parameterized by the corresponding R/G and B/G values. Further, and as illustrated in FIG. 3C, mapping 340 also identifies standard illuminant data point 324.

TCR block 242 can obtain the AWB calibration gain values from database 204, e.g., from AWB calibration gain value data 224, or from AWB correction block 240 through programmatic interface, such as an API. In some examples, TCR block 242 can also perform operations that correct the red, green, and blue color component values associated with facial region 302 (e.g., as represented by facial data points 342 within FIG. 3C) in accordance with the AWB calibration gain values. Based on the corrected red, green, and blue color component values, TCR block 242 can generate data establishing the true color reference for user face 110A (as represented generally by data points 344 within the two-dimensional mapping of FIG. 3C) under the standard illuminant, e.g., the perfect gray illuminant described herein. TCR block 242 can perform additional operation that store the data characterizing the true color reference, such, but not limited to, the corrected red, green, and blue color component values, or the mapped color component ratios, within a corresponding portion of database 204, e.g., TCR data 226.

Additionally, one or more of the exemplary, face-assisted AWB calibration processes described herein may enable the user to provide input to mobile device 102 (e.g., via input unit 215) that specifies one or more fine adjustments or modifications to the generated true color reference data. For example, the user input may specify a modification or adjustment that “fine-tunes” one or more visual characteristics of the generated true color reference to reflect a preference of the user, such as, but not limited to, a preference for a facial tone, a preference for a brightness (or shininess) of the user face, or a preference for a shading or a contrast of the user's face. In some instances, and based on the received user input, TCR tuning block 244 can access portions of the stored TCR data 226 within database 204, and perform operations that modify the accessed portions of the stored TCR data 226 to reflect the adjustments or modifications specified within the received user input.

Referring back to FIG. 2, face-assisted AWB correction block 236 provides a means for computing AWB correction gain values that, when applied to color component values associated with a facial region of a newly captured image that includes the user's face, correct the color component values for consistency with, and conformance to, the true color reference of the user's face. By way of example, face-assisted AWB correction block 236 can access database 204 and obtain, from sensor data 216, facial region data that specifies the triplets of color component values associated the facial region of the newly captured image (e.g., the red, green, and blue color component values). As described herein, ROI detection block 232 may, when executed by processor 208, perform operations that identify a subset of the sensing elements associated with the facial region of the newly captured image, and that incorporate, within the facial region data, the color component values measured by each of the subset of the sensing elements.

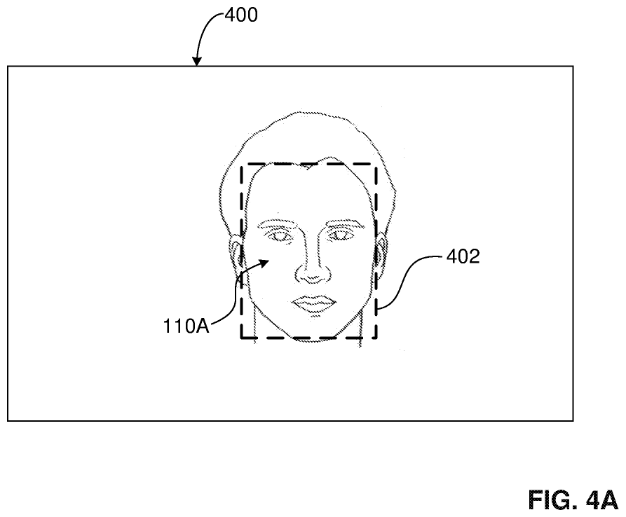

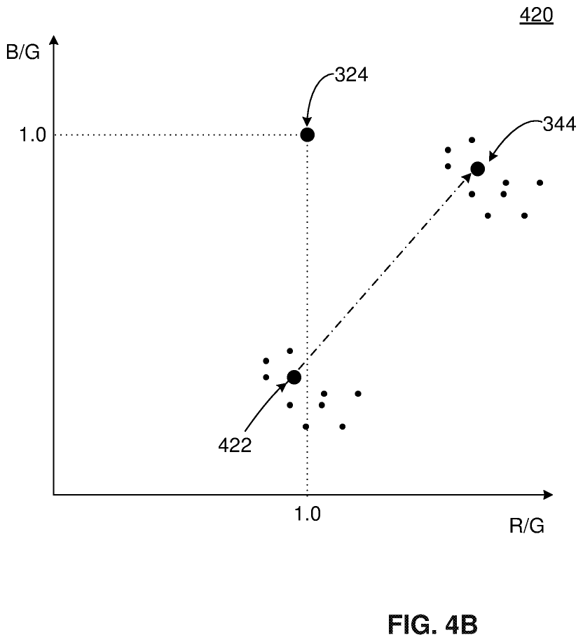

For instance, and as illustrated in FIG. 4A, the newly captured image, e.g., image 400, includes a facial region 402 that incorporates a portion of the user's face (e.g., user face 110A). As described herein, front-facing imaging assembly 106 (or in some instances, rear-facing imaging assembly 212) can capture image 400, and sampling block 230 of mobile device 102 can perform any of the exemplary processes described herein to store data specifying the measured luminance values and/or color component values within a corresponding portion of database 204, e.g., within sensor data 216. Further, ROI detection block 232 can perform any of the exemplary processes described herein to generate, and store within sensor data 216, the facial region data that identifies facial region 402 and that specifies the triplets of color component values measured by the sensing elements associated with facial region 402.

Face-assisted AWB correction block 236 can also access face-assisted AWB calibration data 220, and obtain, from TCR data 226, data that characterizes the true color reference for user face 110A. In some instances, the obtained data may include red, green, and blue color component values that collectively establish the true color image, and additionally, or alternatively, may include R/G and B/G color component ratios derived from the color component values. As described herein, face-assisted AWB calibration block 234 may perform any of the exemplary processes described herein to generate the true color reference for user face 110A.

In some examples, face-assisted AWB correction block 236 can process the facial region data (associated with the facial region 402) to compute an R/G color component ratio and a B/G color component ratio for each triplet of color component values (e.g., the red, green, and blue color component values) included within the facial region data. Face-assisted AWB correction block 236 can also map (and in some instances, quantize) the computed R/G and B/G color component ratios that characterize facial region 402 into a grid within a two-dimensional coordinate space, e.g., as parameterized by the R/G and B/G color component ratios. Further, face-assisted AWB correction block 236 can also obtain, or compute, the R/G and B/G color component ratios for each triplet of corrected color component values included within the data that characterizes the true color reference of user face 110A.

FIG. 4B illustrates an exemplary mapping 420 of the color component ratios of facial region 402, shown generally as facial data points 422, within the two-dimensional coordinate space parameterized by the corresponding R/G and B/G color component values. Further, and as illustrated in FIG. 4B, mapping 420 also identifies data point 324 characterizing the standard illuminant (e.g., the perfect gray illuminant having corresponding R/G and B/G values of unity), and data points 344, which represent generally the true color reference of user face 110A under the standard illuminant.

Face-assisted AWB correction block 236 can perform any of the exemplary processes described herein to compute the AWB correction gain values that, when applied to the red, green, and blue color component values associated with facial region 402 (as represented by illuminant data points 422 within the two-dimensional coordinate space of FIG. 4B), and generate corrected color component values that are consistent with, and conform to, the true color reference of user face 110A under the standard illuminant (e.g., as represented by true color reference data points 344 of FIG. 4B). In some instances, and based on portions of the facial region data and the true color reference data, face-assisted AWB correction block 236 can perform operations that compute average R/G and B/G color component ratios that characterize facial region 402 and further, that characterize the true color reference of user face 110A.

Further, to compute the AWB correction gain values for the red, green, and blue color component values associated with facial region 402, face-assisted AWB correction block 236 perform operations that invert a color correction matrix (CCM) capable of transforming the color component values of facial region 402 into the true color reference. For example, and based on the inversion of the corresponding CCM, the AWB correction gain values for each of the red (R), blue (B), and green (G) color component values can take the following form:

R_{gain value}=(R/G)_{TCR}/(R/G)_{IMAGE};

B_{gain value}=(B/G)_{TCR}/(B/G)_{IMAGE}; and

G_{gain value}=1,

where R_{gain value}, B_{gain value}, and G_{gain value} represent respective red, green, and blue components of AWB correction gain values, (R/G)_{TCR} and (B/G)_{TCR} represent corresponding ones of the average R/G and B/G color component ratios of the true color reference data, and (R/G)_{IMAGE} and (B/G)_{IMAGE} represent corresponding ones of the average R/G and B/G color component ratios across the facial region 402 of the newly captured image. In some instances, face-assisted AWB correction block 236 can perform additional operation that store the AWB correction gain values within a corresponding portion of database 204, e.g., within AWB correction settings 228.

Referring back to FIG. 2, image processing block 238 can provide means for generating corrected image data based on an application the AWB correction gain values to each of the red, green, and blue color component values that characterize the newly captured image. For example, image processing block 238 can access database 204, and obtain, from sensor data 216, image data that characterizes an image newly captured by front-facing imaging assembly 106 (or in some instances, by rear-facing imaging assembly 212), such as, but not limited to, newly captured image 400 of FIG. 4A. As described herein, the obtained image data specifies luminance values and/or values of red, green, and blue color components measured by each sensing element incorporated within front-facing imaging assembly 106 or rear-facing imaging assembly 212.

Further, image processing block 238 can also obtain, from AWB correction settings 228, data specifying AWB correction gain values that, when applied to the red, green, and blue color component values of the image data, correct these color component values for consistency with the true color reference of the face of the user of mobile device 102, e.g., user face 110A of FIGS. 3A and 4A. In some examples, image processing block 238 can generated corrected image data based on an application of the AWB correction gain values (e.g., the values of R_{gain value}, B_{gain value}, and G_{gain value} described herein) to corresponding ones of the red, green, and blue color component values specified within the obtained image data. Image processing block 238 can perform operations that store the corrected image data within a corresponding portion of database 204, e.g., within sensor data 216.

As described herein, the corrected image data reflects a correction of the color balance of the newly captured image based not on an explicitly or implicitly selected standard illuminant, but instead based on a true color reference of the user's face. Further, the exemplary face-assisted AWB correction processes, when implemented by mobile device 102, can reduce inaccuracies in the corrected image data and reduce visible defects that become evident upon presentation of the corrected image data, e.g., via display unit 104, without requiring additional image collection or processing hardware.

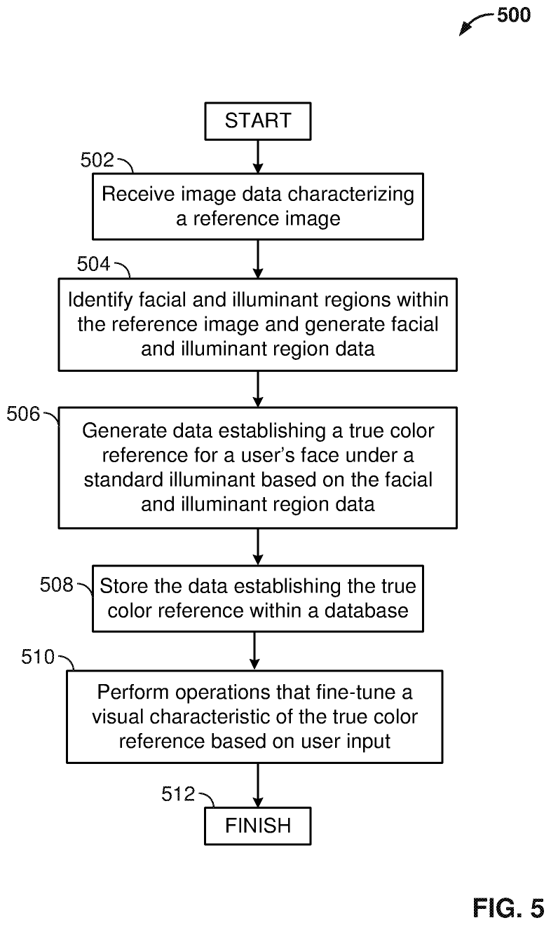

FIG. 5 is a flowchart of example process 500 for performing a face-assisted calibration of an automatic white balancing (AWB) operation based on reference image data, in accordance with one implementation. Process 500 can be performed by one or more processors executing instructions locally at an image capture device, such as processors 208 of mobile device 102 of FIG. 2. Accordingly, the various operations of process 500 can be represented by executable instructions held in storage media of one or more computing platforms, such as storage media 202 of mobile device 102.

For example, as described above, mobile device 102 can include one or more front-facing or rear-facing digital cameras (e.g., front-facing imaging assembly 106 or rear-facing imaging assembly 212 of FIG. 2). As described herein, each of the digital cameras can include one or more optical elements and lenses configured to collimate and focus incoming light onto an array of sensors, which generate an electrical signal indicative of a measured value of a luminance, or values of corresponding color components, of the collected light.

Referring to block 502 in FIG. 5, mobile device 102 (FIG. 2) can perform operations that receive image data characterizing a reference image. For example, and as described herein, the reference image can include a portion of a face of a user of mobile device 102, and the user's face can be disposed against a background having a specified color or range of colors, such as, but not limited to, a white background or a gray background. Further, in some instances, the front-facing digital camera of mobile device 102 can be configured to capture the reference image, e.g., during a performance of any of the exemplary initial configuration processes described herein.

For example, sampling block 230 (FIG. 2), when executed by processor 208 (FIG. 2) of mobile device 102, can receive the measured values of luminance and/or color components (e.g., red, green, and blue color components) from the sensor array of the front-facing digital camera. The luminance values and/or the received color component values collectively establish reference image data that characterizes the captured reference image, and sampling block 230 can perform operations in block 502 that store the reference image data with a portion of a database, such as within sensor data 216 of database 204 (FIG. 2).

In block 504, mobile device 102 can perform additional operations that identify a facial region and an illuminant region within the captured reference image. As described herein, the facial region of the captured reference image includes all or a portion of the user's face, and the illuminant region includes a portion of the background of the captured reference image, such as, but not limited to, the gray background or the white background. For example, ROI detection block 232 (FIG. 2) can detect the facial region and the illuminant region the captured reference image based on an application of one or more facial recognition algorithms or feature detection algorithms to the portions of the image data (e.g., the received luminance or color component values) that characterize the captured reference image. Further, ROI detection block 232 can also perform operations that identify and store data characterizing the detected facial and illuminant regions, such as the triplets of color component values (e.g., red, green, and blue color component values) measured by sensing elements associated with respective ones of the detected facial and illuminant regions, within database 204, e.g., within sensor data 216.

At block 506, mobile device 102 can perform operations that generate data establishing a true color reference for the user's face based on the color component values associated with the detected feature and illuminant regions. For example, when executed by processor 208 of mobile device 102, AWB correction block 240 (FIG. 2) can perform any of the exemplary processes described herein to compute AWB calibration gain values that, when applied to the color component values associated with the detected illuminant region, correct those color component values for consistency with, and conformance to, a standard illuminant. Examples of the standard illuminant include, but is not limited to, a perfect gray illuminant characterized by a red-to-green (R/G) color component ratio and a blue-to-green (B/G) color component ratio of unity.

As described herein, AWB correction block 240 can perform operations that access database 204 and extract, from sensor data 216, illuminant region data that specifies the triplets of color component values (e.g., red, green, and blue color component values) measured by corresponding ones of the sensing elements associated with the detected illuminant region. AWB correction block 240 can also perform operations that compute R/G color component ratio and B/G color component ratio for each of the triplets of the color component values included within the illuminant region data.

Further, AWB correction block 240 can map, and in some instances, quantize the R/G and B/G color component ratios associated with the detected illuminant region into a grid within a two-dimensional coordinate space, e.g., as parameterized by the R/G and B/G color component ratios. Based on the mapping of the color component ratios onto the two-dimensional, coordinate space, AWB correction block 240 can perform any of the exemplary processes described herein to compute AWB calibration gain values that, when applied to the color component values associated with the detected illuminant region, correct those color component values for consistency with, and conformance to, the standard illuminant.

Further, when executed by processor 208 of mobile device 102, TCR block 242 (FIG. 2) can perform any of the exemplary, face-assisted AWB calibration processes described herein to compute the true color reference for the user's face based on an application of the computed AWB calibration gain values to the color component values associated with the detected facial region of the reference image. For instance, TCR block 242 can access database 204, and obtain facial region data from a corresponding portion of sensor data 216.

As described herein, the facial region data specifies the triplets of color component values (e.g., red, green, and blue color component values) measured by corresponding ones of the sensing elements associated with the detected facial region, and TCR block 242 can perform operations that compute R/G and B/G color component ratios for each of the triplets of the color component values included within the facial region data. In some examples, TCR block 242 can perform additional operations that correct the red, green, and blue color component values (and additionally, or alternatively, the R/G and B/G color component ratios) associated with the detected facial region. Based on the corrected red, green, and blue color component values (and additionally, or alternatively, the corrected R/G and B/G color component ratios), TCR block 242 can establish the true color reference for the user's face under the standard illuminant.

Referring back to FIG. 5, at block 508, mobile device 102 can perform operations that store the data establishing and characterizing the true color reference of the user's face within a corresponding portion of database 204. For example, and as described herein, TCR block 242 can perform additional operation that store the data characterizing the true color reference, such, but not limited to, the corrected red, green, and blue color component values, or the corrected R/G and B/G color component ratios, within TCR data 226 of face-assisted AWB calibration data 220.

Further, and at block 510, mobile device 102 can perform additional operations that “fine-tune” the established true color reference for the user's face to account for one or more preferences of the user. For example, and as described herein, mobile device 102 can perform operations that present the corrected red, green, and blue color component values, which collective establish the true color references, to the user within a corresponding interface (e.g., as displayed on display unit 104), along with additional interface elements that prompt the user to provide input modifying one or more visual characteristics of the true color reference. The additional interface elements may, in some instances, prompt the user to lighten or darken the true color reference in accordance with a preferred facial tone, prompt the user to modify a brightness of the true color reference in accordance with a preferred level of brightness or shininess, or prompt the user to modify a preference for a shading or a contrast of the true color reference in accordance with a corresponding preference. Input unit 215 of mobile device 102 can receive the user input, and upon execution by processor 208 of mobile device 102, TCR tuning block 244 (FIG. 2) can access portions of the stored data characterizing and establishing the true color reference of the user's face, and perform operations that modify the portions of the stored data to reflect the adjustments or modifications specified within the user input. Exemplary process 500 is then completed in block 512.

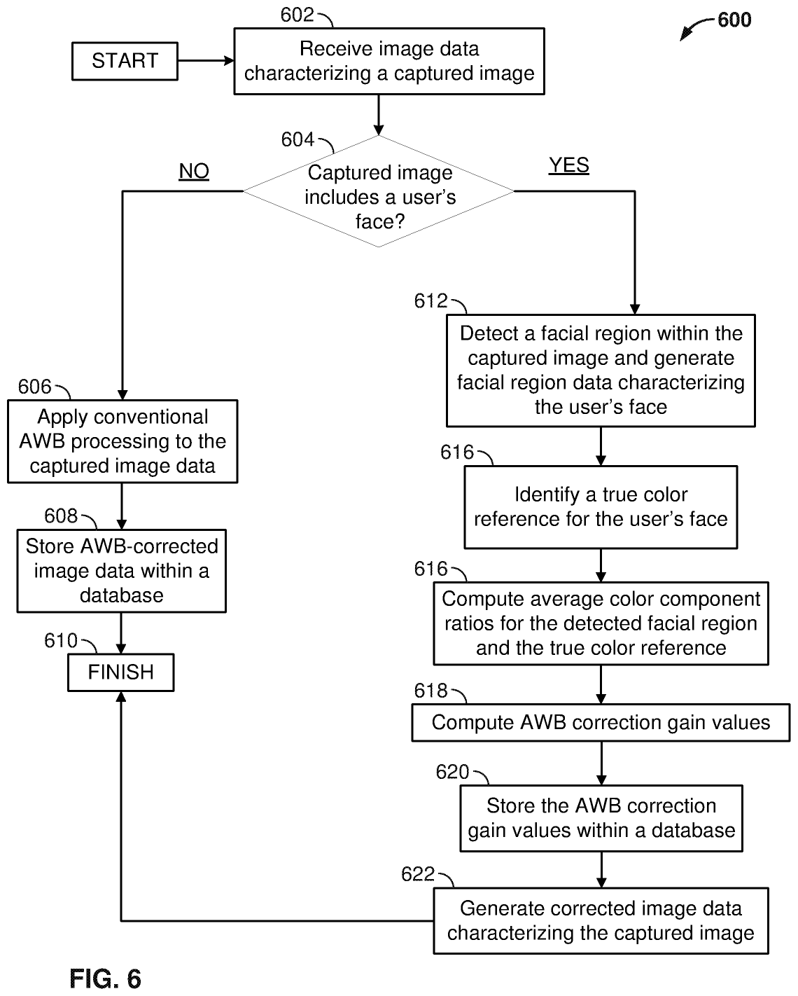

FIG. 6 is a flowchart of example process 600 for performing a face-assisted automatic white balancing (AWB) operation, in accordance with one implementation. Process 600 can be performed by one or more processors executing instructions locally at an image capture device, such as processors 208 of mobile device 102 of FIG. 2. Accordingly, the various operations of process 600 can be represented by executable instructions held in storage media of one or more computing platforms, such as storage media 202 of mobile device 102.

Referring to block 602 in FIG. 6, mobile device 102 (FIG. 2) can perform operations that receive image data characterizing a captured image of a target scene. As described above, mobile device 102 can include one or more front-facing or rear-facing digital cameras (e.g., front-facing imaging assembly 106 or rear-facing imaging assembly 212 of FIG. 2), and in some instances, the image can be captured by either the front-facing digital camera (e.g., as a “selfie” or for purposes of authentication through one or more facial authentication processes implemented by mobile device 102) or by the rear-facing digital camera (e.g., to capture a portion of the environment in which mobile device 102 operates). Further, each of the front- and rear-facing digital cameras can include one or more optical elements and lenses configured to collimate and focus incoming light onto sensing element arranged into a sensor array, which generate an electrical signal indicative of a measured value of a luminance, or values of corresponding color components, of the collected light.

For example, sampling block 230 (FIG. 2), when executed by processor 208 (FIG. 2) of mobile device 102, can receive the measured values of luminance and/or color components (e.g., triplets of red, green, and blue color component values) from the sensor array of the front- or rear-facing digital camera. The luminance values and/or the received color component values collectively establish reference image data that characterizes the captured image, and sampling block 230 can perform operations in block 602 that store the image data with a portion of a database, such as within sensor data 216 of database 204 (FIG. 2).

At block 604, mobile device 102 can perform additional operations that determine whether the captured image includes all or a portion of a face of a user of mobile device 102. For example, when executed by processor 208, ROI detection block 232 (FIG. 2) can apply of one or more facial recognition algorithms or feature detection algorithms to the portions of the image data (e.g., the received luminance or color component values), and based on the application of the one or more facial recognition algorithms or feature detection algorithms, determine whether the captured image data includes any portion of the user's face.

If the captured image data were to include no portion the user's face (e.g., block 604; NO), block 606 is executed. Alternatively, if mobile device 102 were to detect a presence of all of a portion of the user's face within the captured image data (e.g., block 604; YES), block 612 is executed.

Referring to block 606, mobile device 102 may perform operations that apply one or more conventional automatic white balancing (AWB) processes to portions of the captured image data. For example, when executed by processor 208 of mobile device 102, AWB correction block 240 can access the captured image data, and perform an independent gain regulation of each color component of the captured image data (e.g., red, green, and blue color components) to generate “corrected” image data that corresponds to corresponding to an image of the target scene captured under a standard illuminant. By way of example, the standard illuminant may be estimated explicitly by the conventional AWB processes or may be estimated implicitly through one or more assumptions regarding an effect or impact of the standard illuminant on the corrected image data.

At block 608, mobile device 102 can perform operations that store the corrected image data, e.g., as generated using the conventional AWB processes described herein, within a corresponding portion of database 204. Exemplary process 600 is then complete in block 610.

Alternatively, and referring to block 612, mobile device 102 can perform additional operations that generate information characterizing a facial region within the captured image data. For example, when executed by processor 208, ROI detection block 232 can perform operations that detect the facial region within the captured image data, e.g., that includes all or a portion of the user's face, and generate facial region data that characterizes the detected facial region. As described herein, ROI detection block 232 can identify a subset of the sensing elements that are associated with the detected facial region of the captured image, and incorporate, into the facial region data, the triplets of the color component values measured by identified subset of the sensing elements. ROI detection block 232 can perform additional operations that store the generate facial region data within a corresponding portion of database 204, e.g., within an additional portion of sensor data 216.

At block 614, mobile device 102 can perform additional operations that identify a true color reference associated with the user's face. For example, when executed by processor 208 of mobile device 102, a face-assisted AWB correction block 236 (FIG. 2) can access database 204 and obtain, from TCR data 226 (FIG. 2), data that establishes a true color reference for the user's face. As described herein, the obtained data may include values of color components (e.g., triplets of red, green, and blue color components) and additionally or alternatively, values of R/G and B/G color component ratios that establish the true color reference of the user's face under a standard illuminant. Examples of the standard illuminant include, but are not limited to, the perfect gray illuminant described herein.

Further, at block 616, mobile device 102 can perform operations that compute an average of corresponding R/G and B/G color component ratios for both the detected facial region within the captured image data (e.g., that includes the user's face) and the established true color reference of the user's face. By way of example, when executed by processor 208, face-assisted AWB correction block 236 can access database 204 and obtain the facial region data from a portion of sensor data 216. As described herein, the facial region data can include the triplets of the color component values (e.g., the red, green, and blue color component values) measured by the sensing elements associated with the detected facial region, and additionally, or alternatively, the R/G and B/G color component ratios that characterize the triplets of the color component values.

In some instances, face-assisted AWB correction block 236 can perform any of the exemplary processes described herein to compute the average R/G and B/G color component ratios across the facial region of the captured image based on corresponding ones of the red, green, and blue color component values and/or the R/G and B/G color component ratios specified within the facial region data. Further, face-assisted AWB correction block 236 can perform similar operations that compute the average R/G and B/G color component ratios for the true color reference of the user's face based on corresponding portions of the true color reference data obtained from TCR data 226.

Referring back to FIG. 6, at block 618, mobile device 102 can perform additional operations to compute AWB correction gain values that, when applied to the color component values associated with the facial region of the captured image, correct the color component values for consistency with, and conformance to, corresponding color component values that establish the true color reference for the user's face. In some instances, when executed by processor 208 of mobile device 102, face-assisted AWB correction block 236 can perform any of the exemplary processes described herein to compute the AWB correction gain values based on the average R/G and B/G color component ratios computed for, or obtained for, the facial region that includes the user's and the true color reference that characterizes the user's face. For example, the AWB correction gain values for each of the red (R), blue (B), and green (G) color component values can take the following form:

R_{gain value}=(R/G)_{TCR}/(R/G)_{IMAGE};

B_{gain value}=(B/G)_{TCR}/(B/G)_{IMAGE}; and

G_{gain value}=1,

where R_{gain value}, B_{gain value}, and G_{gain value} represent respective red, green, and blue components of AWB correction gain values, (R/G)_{TCR} and (B/G)_{TCR} represent corresponding ones of the average R/G and B/G color component ratios of the true color reference, and (R/G)_{IMAGE} and (B/G)_{IMAGE} represent corresponding ones of the average R/G and B/G color component ratios within the facial region of the captured image.

Further, and in reference to block 620 of FIG. 6, mobile device 102 can perform operations that store the computed AWB correction gain values within a corresponding portion of database 204. For example, face-assisted AWB correction block 236 can access database 204, and store the AWB correction gain values within a corresponding portion of AWB correction settings 228.

At block 622, mobile device 102 can perform additional operations that generate corrected image data based on an application the AWB correction gain values to each of the red, green, and blue color component values that characterize the captured image. For example, upon execution by processor 208, image processing block 238 (FIG. 2) can access database 204, and obtain, from sensor data 216, the image data that characterizes the image of the target scenes captured by the front- or rear-facing digital camera. As described herein, the obtained image data specifies luminance values and/or values of red, green, and blue color components measured by each sensing element incorporated within the front- or rear-facing digital camera.

Further, image processing block 238 can also obtain, from AWB correction settings 228, data specifying AWB correction gain values that, when applied to the red, green, and blue color component values of the image data, correct these color component values for consistency with corresponding color component values that characterize the true color reference of the user's face. In some examples, image processing block 238 can generated corrected image data based on an application of the AWB correction gain values (e.g., the values of R_{gain value}, B_{gain value}, and G_{gain value} described herein) to corresponding ones of the red, green, and blue color component values specified within the obtained image data. Image processing block 238 can perform operations that store the corrected image data within a corresponding portion of database 204, e.g., within sensor data 216. Exemplary process 600 is then complete in block 610.

The methods, systems, and devices described herein can be at least partially embodied in the form of computer-implemented processes and apparatus for practicing the disclosed processes. The disclosed methods can also be at least partially embodied in the form of tangible, non-transitory machine-readable storage media encoded with computer program code. The media can include, for example, random access memories (RAMs), read-only memories (ROMs), compact disc (CD)-ROMs, digital versatile disc (DVD)-ROMs, “BLUE-RAY DISC”™ (BD)-ROMs, hard disk drives, flash memories, or any other non-transitory machine-readable storage medium. When the computer program code is loaded into and executed by a computer, the computer becomes an apparatus for practicing the method. The methods can also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods can alternatively be at least partially embodied in application specific integrated circuits for performing the methods. In other instances, the methods can at least be embodied within sensor-based circuitry and logic.

The subject matter has been described in terms of exemplary embodiments. Because they are only examples, the claimed inventions are not limited to these embodiments. Changes and modifications can be made without departing the spirit of the claimed subject matter. It is intended that the claims cover such changes and modifications.

We claim:

1. A method for performing automatic white balancing, comprising:
receiving, by one or more processors, first image data from a plurality of sensing elements in a sensor array, the first image data corresponding to an image of a target scene that includes a human face;
by the one or more processors, detecting a region of the image that includes the human face and identifying a portion of the first image data that corresponds to the detected region;
computing, by the one or more processors, first gain values based on the identified portion of the first image data and reference image data that characterizes the human face; and
performing, by the one or more processors, an automatic white balancing operation on the first image data based on the first gain values.

2. The method of claim 1, wherein the reference image data establishes a true color reference for the human face under a standard illuminant.

3. The method of claim 2, wherein the standard illuminant comprises a perfect gray illuminant.

4. The method of claim 1, wherein the identifying comprises:
determining that a subset of the sensing elements correspond to the detected region of the image; and
establishing that the portion of the first image data is received from the subset of the sensing elements.

5. The method of claim 1, wherein:
the first image data comprises values of color components measured by each of the plurality of sensing elements; and
the reference image data comprises reference values of the color components, the reference values establishing a true color reference for the human face under a standard illuminant.

6. The method of claim 5, wherein the identifying comprises:
determining that a subset of the sensing elements correspond to the detected region of the image;
extracting, from the first image data, one or more of the values of the color components measured by the subset of the sensing elements; and
establishing the extracted values of the color components as the identified portion of the first image data.

7. The method of claim 5, wherein the computing comprises:
determining color component ratios based on the values of the color components;
determining reference color component ratios based on the reference values of the color components; and
computing the first gain values based on the color component ratios and the reference color component ratios.

8. The method of claim 1, further comprising
receiving second image data from the plurality of sensing elements in the sensor array, the second image data corresponding to a reference image that includes a human face and a background;
detecting, within the reference image, a first reference region image that includes the human face and a second reference region that includes a portion of the background; and
identifying (i) a first portion of the second image data that corresponds to the first reference region, and (ii) a second portion of the second image data that corresponding to the second reference region.

9. The method of claim 8, further comprising:
obtaining information characterizing a standard illuminant;
computing second gain values based on the second portion of the second image data and the information characterizing the standard illuminant; and
generating the reference image data based on an application of the second gain values to the first portion of the second image data.

10. The method of claim 1, further comprising:
receiving input data from a user, the input data specifying a modification to a visual characteristic of the reference image data, the visual characteristic comprising a color tone, a brightness, or a contrast associated with the reference image data;
accessing and loading the reference image data from a storage unit; and
performing operations that modify a portion of the reference image data in accordance with the specified modification.

11. The method of claim 1, wherein the sensor array is included within at least one of a front-facing imaging assembly or a rear-facing imaging assembly of a device.

12. A device for performing automatic white balancing, comprising:
a non-transitory, machine-readable storage medium storing instructions; and
at least one processor configured to be coupled to the non-transitory, machine-readable storage medium, the at least one processor configured by the instructions to:
receive, first image data from a plurality of sensing elements in a sensor array, the first image data corresponding to an image of a target scene that includes a human face;
detect a region of the image that includes the human face and identify a portion of the first image data that corresponds to the detected region;
compute first gain values based on the identified portion of the first image data and reference image data that characterizes the human face; and
perform an automatic white balancing operation on the first image data based on the first gain values.

13. The device for performing automatic white balancing of claim 12, wherein the reference image data establishes a true color reference for the human face under a standard illuminant.

14. The device for performing automatic white balancing of claim 13, wherein the standard illuminant comprises a perfect gray illuminant.

15. The device for performing automatic white balancing of claim 12, wherein at least one processor is further configured to:
determine that a subset of the sensing elements correspond to the detected region of the image; and
establish that the device received the portion of the first image data from the subset of the sensing elements.

16. The device for performing automatic white balancing of claim 12, wherein:
the first image data comprises values of color components measured by each of the plurality of sensing elements; and
the reference image data comprises reference values of the color components, the reference values establishing a true color reference for the human face under a standard illuminant.

17. The device for performing automatic white balancing of claim 16, wherein the at least one processor is further configured to:
determine that a subset of the sensing elements correspond to the detected region of the image;
extract, from the first image data, one or more of the values of the color components measured by the subset of the sensing elements; and
establish the extracted values of the color components as the identified portion of the first image data.

18. The device for performing automatic white balancing of claim 16, wherein the at least one processor is further configured to:
determine color component ratios based on the values of the color components;
determine reference color component ratios based on the reference values of the color components; and
compute the first gain values based on the color component ratios and the reference color component ratios.

19. The device for performing automatic white balancing of claim 12, wherein the at least one processor is further configured to:
receive second image data from the plurality of sensing elements in the sensor array, the second image data corresponding to a reference image that includes a human face and a background;
detect, within the reference image, a first reference region that includes the human face and a second reference region that includes a portion of the background; and
identify (i) a first portion of the second image data that corresponds to the first reference region, and (ii) a second portion of the second image data that corresponding to the second reference region.

20. The device for performing automatic white balancing of claim 19, wherein the at least one processor is further configured to:
load information characterizing a standard illuminant from the non-transitory, machine-readable storage medium;
compute second gain values based on the second portion of the second image data and the information characterizing the standard illuminant; and
generate the reference image data based on an application of the second gain values to the first portion of the second image data.

21. The device for performing automatic white balancing of claim 12, further comprising an input unit coupled to the at least one processor, wherein the at least one processor is further configured to:
receive input data from a user via the input unit, the input data specifying a modification to a visual characteristic of the reference image data, the visual characteristic comprising a color tone, a brightness, or a contrast associated with the reference image data;
access and load the reference image data from the non-transitory, machine-readable storage medium; and
perform operations that modify a portion of the reference image data in accordance with the specified modification.

22. The device for performing automatic white balancing of claim 12, wherein the sensor array is included within at least one of a front-facing imaging assembly or a rear-facing imaging assembly of the device.

23. An apparatus for performing automatic white balancing, comprising:
means for receiving first image data from a plurality of sensing elements in a sensor array, the first image data corresponding to an image of a target scene that includes a human face;
means for detecting a region of the image that includes the human face and for identifying a portion of the first image data that corresponds to the detected region;
means for computing first gain values based on the identified portion of the first image data and reference image data that characterizes the human face; and
means for performing an automatic white balancing operation on the first image data based on the first gain values.

24. A non-transitory, machine-readable storage medium storing program instructions that, when executed by at least one processor, perform a method for performing automatic white balancing, the machine-readable storage medium comprising:
instructions for receiving first image data from a plurality of sensing elements in a sensor array, the first image data corresponding to an image of a target scene that includes a human face;
instructions for detecting a region of the image that includes the human face and for identifying a portion of the first image data that corresponds to the detected region;
instructions for computing first gain values based on the identified portion of the first image data and reference image data that characterizes the human face; and
instructions for performing an automatic white balancing operation on the first image data based on the first gain values.
